(19) United States
(12) Patent Application Publication
(10) Pub. No.: US 2006/0097963 A1
(43) Pub. Date: May 11, 2006

(54) Driving method of plasma display panel, and plasma display device

(76) Inventor: Joo-Yul Lee, Suwon-si (KR)

Correspondence Address: CHRISTIE, PARKER & HALE, LLP, PO BOX 7068, PASADENA, CA, 91109-7068, US

(21) Appl. No.: 11/203,051

(22) Filed: Aug. 12, 2005

(30) Foreign Application Priority Data
Nov. 9, 2004 (KR) 10-2004-0090858

(51) Int. Cl. G09G 3/28

(52) U.S. Cl. 345/63

(57) ABSTRACT

According to a plasma display device of the present invention, a waveform for erasing a wall charge of an address electrode formed near a sustain electrode is applied during a first period of a sustain period, when a temperature of a PDP is lower that room temperature. Thereby, with an ensuing auxiliary reset, the wall charge formed on the address electrode can be sufficiently controlled, and misfiring during the address period may be prevented.

### CROSS-REFERENCE TO RELATED APPLICATION

This application claims priority to and the benefit of Korean Patent Application No. 10-2004-0090858 filed in the Korean Intellectual Property Office on Nov. 09, 2004, the entire content of which is incorporated herein by reference.

### BACKGROUND OF THE INVENTION

1. Field of the Invention

The present invention relates to a driving method for a plasma display panel (PDP), and a plasma display device.

2. Description of the Related Art

A plasma display device is a flat panel display that uses plasma generated by a gas discharge process to display characters or images. A plasma display device includes a PDP where a plurality of discharge cells are provided in a matrix format.

The plasma display device is driven by a plurality of subfields, which are time intervals divided from a frame, and each have their respective weight values. Each subfield has a reset period, an address period, and a sustain period.

The reset period is for initializing the discharge cells so that the next addressing can be stably performed. The address period is for selecting turn-on/turn-off discharge cells (i.e., cells to be turned on or off). The sustain period is for causing a sustained discharge for displaying an image on the addressed discharge cells.

One of the characteristics of the plasma display device is that discharge voltage and discharge characteristics of a PDP vary according to temperature. When the temperature increases, the discharge voltage decreases, and when the temperature decreases, the discharge voltage is inclined to increase. In addition, at a high temperature, an opposed discharge between a scan electrode Y and an address electrode A occurs easily, and at a low temperature, the opposed discharge occurs with difficulty. Therefore, when initializing a discharge cell in which a sustain discharge has occurred during a previous subfield, a wall charge formed on an address electrode A near the scan electrode Y can be erased using waveforms of FIG. 1, but a wall charge formed on an address electrode A near the sustain electrode X may not be erased, and a large amount of charge may remain on the address electrode A. When a large amount of charge remains on the address electrode A, an address discharge misfire may occur during the subsequent address period.

The above information disclosed in this Background section is only for enhancement of understanding of the background of the invention. Therefore, it may contain information that does not form the prior art that is already known in this country to a person of ordinary skill in the art.

### SUMMARY OF THE INVENTION

The present invention provides a PDP and a plasma display device that prevent a misfire during an address period by initializing a discharge cell in which a sustain discharge has occurred during a previous subfield.

An exemplary driving method of a PDP according to an embodiment of the present invention includes dividing a frame into a plurality of subfields comprising a reset period, an address period and a sustain period, wherein the PDP includes a plurality of first electrodes, a plurality of second electrodes, and a plurality of third electrodes formed in a direction crossing the direction of the first and the second electrodes.

During the sustain period, the method further includes alternately applying a plurality of sustain discharge pulses having a first voltage to a first electrode and a second electrode for a sustain discharge, and applying an erase waveform for erasing a wall voltage of a third electrode formed near the second electrode during a first period of the sustain period. The first period of the sustain period generally means a period during which the last sustain discharge pulse for the sustain electrode X is applied to the sustain electrode X during the sustain period.

In a further embodiment, the first period of the sustain period substantially includes a period for applying a last sustain discharge pulse for the second electrode to the second electrode.

In a still further embodiment, the erase waveform has a narrower pulse width during the first period than a width of a sustain discharge pulse applied to the second electrode.

In a still further embodiment, the erase waveform has a lower voltage during the first period than the first voltage applied to the second electrode.

In a still further embodiment, the erase waveform biases the second electrode with a negative voltage after applying a sustain voltage to the second electrode.

In a still further embodiment, the erase waveform biases the third electrode with a positive voltage during application of a sustain discharge pulse to the second electrode.

In a still further embodiment, a last sustain discharge pulse among the plurality of the sustain discharge pulses during the sustain period is applied to the first electrode.

In a still further embodiment, during a reset period following the sustain period, the voltage of the first electrode is gradually decreased after applying the last sustain discharge pulse to the first electrode.

An exemplary driving method of a PDP according to another embodiment of the present invention includes applying a sustain discharge pulse to a first electrode and a second electrode during a sustain period, wherein the PDP includes a plurality of first electrodes, a plurality of second electrodes, and a plurality of third electrodes formed in a direction crossing the direction of the first and the second electrodes.

A temperature of the PDP is detected, and an erase waveform for erasing a wall voltage of a third electrode formed near the second electrode is applied during a first period of the sustain period when the detected temperature is lower than room temperature.

In a further embodiment, the first period of the sustain period substantially includes a period for applying a last sustain discharge pulse to the second electrode.

In a still further embodiment, the erase waveform has a narrower pulse width during the first period than a width of a sustain discharge pulse applied to the second electrode.

In a still further embodiment, the erase waveform has a voltage during the first period lower than the first voltage applied to the second electrode.

In a still further embodiment, the erase waveform biases. the second electrode with a negative voltage after applying a sustain voltage to the second electrode.

In a still further embodiment, the erase waveform biases the third electrode with a positive voltage during application of a sustain discharge pulse to the second electrode.

In a still further embodiment, a last sustain discharge pulse among the plurality of the sustain discharge pulses during the sustain period is applied to the first electrode.

In a still further embodiment, during a reset period following the sustain period, the voltage of the first electrode is gradually decreased after applying the last sustain discharge pulse to the first electrode.

An exemplary PDP including a plurality of scan electrodes, a plurality of sustain electrodes, and a plurality of address electrodes formed in a direction crossing the direction of the scan and sustain electrodes according to the present invention includes a temperature detector, a driver, and a controller.

The temperature detector detects a temperature of the PDP.

The driver performs a sustain discharge between the scan electrode and the sustain electrode by applying a sustain discharge pulse to the scan electrode and the sustain electrode during a sustain period.

The controller controls the driver based on the temperature of the PDP during a first period of the sustain period so that a wall charge formed on the plurality of the address electrodes may be erased.

In a further embodiment, during the first period, when the temperature of the PDP is lower than a first temperature, the controller controls the driver so that the wall charge formed on the plurality of the address electrodes may be erased.

In a still further embodiment, the first period of the sustain period comprises a period for applying a last sustain discharge pulse for the plurality of the sustain electrodes to the plurality of the sustain electrodes.

In a still further embodiment, during a reset period following the sustain period, the driver initializes a discharge cell in which a sustain discharge has occurred during the sustain period.

### BRIEF DESCRIPTION OF THE DRAWINGS

FIG. 1 shows a driving waveform of a conventional PDP.

FIG. 2 shows a plasma display device according to an exemplary embodiment of the present invention.

FIG. 3 illustrates an operation of a controller shown in FIG. 2.

FIG. 4 illustrates an operation of a controller for driving an erase mode.

FIGS. 5, 6, 7, and 8 respectively show driving waveforms of the PDP according to first, second, third, and fourth exemplary embodiments of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

A wall charge mentioned in the present invention means charges formed and accumulated on a wall (e.g., a dielectric layer) close to an electrode of a discharge cell. Although the wall charges do not actually touch the electrodes, herein the wall charge will be described as being “formed” or “accumulated” on the electrode. A wall voltage means a potential difference formed on a wall of a discharge cell by the wall charge.

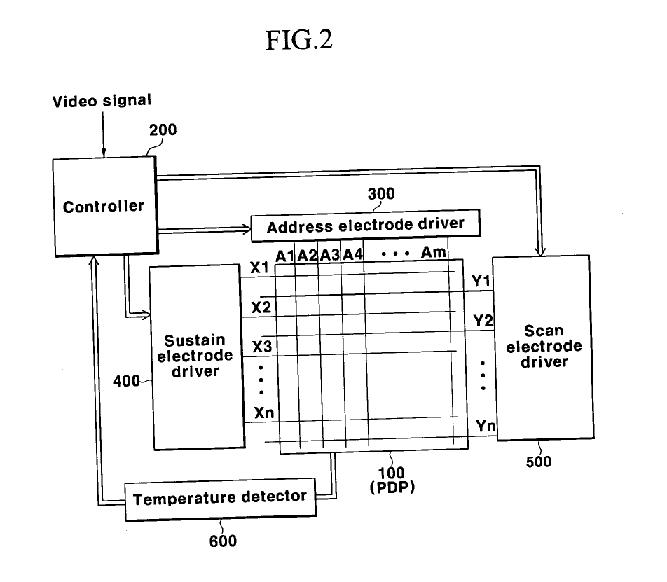

FIG. 2 shows the plasma display device according to an exemplary embodiment of the present invention.

As shown in FIG. 2, the plasma display device according to an exemplary embodiment of the present invention includes a PDP 100, a controller 200, an address electrode driver 300, a sustain electrode driver 400, a scan electrode driver 500, and a temperature detector 600.

The PDP 100 includes a plurality of address electrodes A1 to Am extending along a column direction, and a plurality of sustain electrodes X1 to Xn and scan electrodes Y1 to Yn which extend along a row direction and are paired with each other. Generally, the sustain electrodes X1 to Xn are formed corresponding to the scan electrodes Y1 to Yn, respectively. The PDP 100 includes a substrate (not shown) where the sustain and scan electrodes (i.e., X1 to Xn and Y1 to Yn) are arranged, and another substrate where the address electrodes A1 to Am are arranged. The two substrates are placed facing each other with a discharge space therebetween so that the directions of the scan electrodes Y1 to Yn and the address electrodes A1 to Am may perpendicularly cross each other, and directions of the sustain electrodes X1 to Xn and the address electrodes A1 to Am may also perpendicularly cross each other. The discharge space at a crossing region of the address electrodes A1 to Am with the sustain and scan electrodes X1 to Xn, and Y1 to Yn forms a discharge cell. This structure of the PDP 100 is merely exemplary, and panels of other structures can be used in the present invention as well.

The controller 200 receives an external video signal, outputs an address electrode driving control signal, a sustain electrode driving control signal, and a scan electrode driving control signal, and controls the plasma display device by dividing a frame into a plurality of subfields having different brightness weight values. In order to erase the wall charge formed on the address electrode A near the sustain electrode X, the controller 200 outputs the address electrode driving control signal, the sustain electrode driving control signal, and the scan electrode driving control signal according to a temperature of the PDP 100 detected by the temperature detector 600 and provided to the controller 200.

The address electrode driver 300 receives the address electrode driving control signal from the controller 200, and applies a display data signal for selecting a discharge cell to be discharged to each address electrode A.

The sustain electrode driver 400 receives the sustain electrode driving control signal from the controller 200, and applies a driving voltage to the sustain electrode X.

The scan electrode driver 500 receives the scan electrode driving control signal from the controller 200, and applies the driving voltage to the scan electrode Y.

The temperature detector 600 detects the temperature of the PDP 100, and provides it to the controller 200.

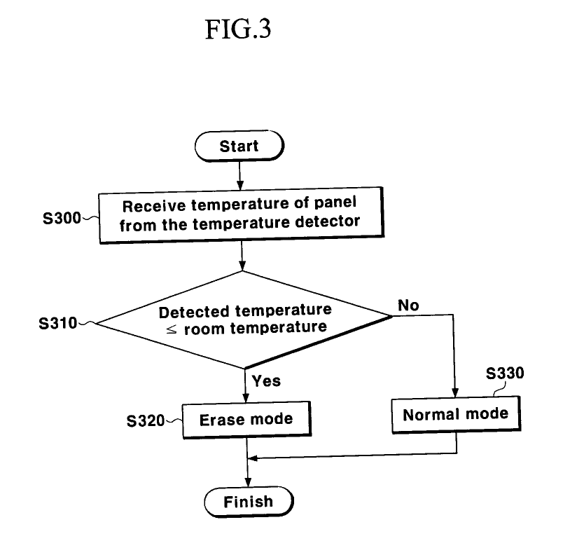

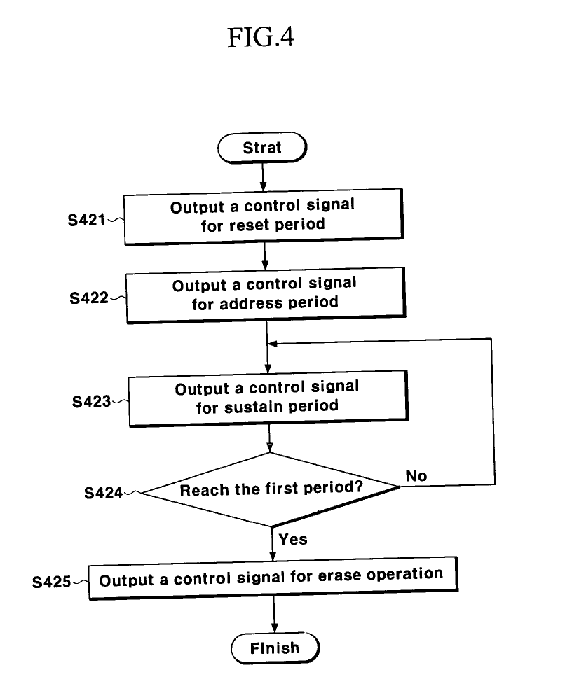

Next, referring to FIG. 3 and FIG. 4, an operation of the controller of the plasma display device according to an exemplary embodiment of the present invention will be described in detail.

FIG. 3 illustrates the operation of the controller shown in FIG. 2.

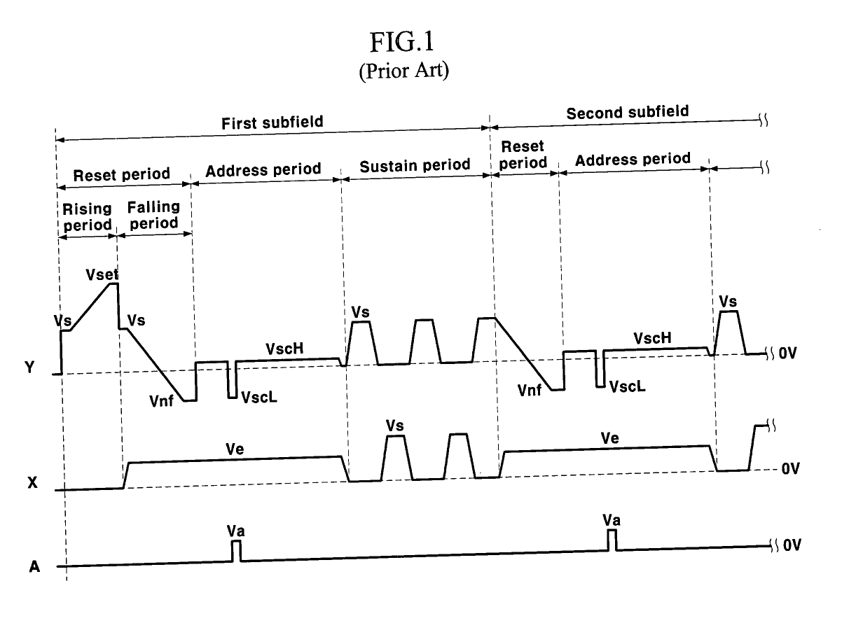

As shown in FIG. 3, the controller 200 receives the temperature information of the PDP 100 detected by the temperature detector 600 in S300, and compares it with a predetermined temperature (hereinafter, room temperature) in S310. When the detected temperature is less than or equal to room temperature, the controller 200 outputs the address electrode driving control signal, the sustain electrode driving control signal, and the scan electrode driving control signal for driving an erase mode in S320. On the other hand, when the detected temperature is greater than room temperature, the controller 200 outputs the address electrode driving control signal, the sustain electrode driving control signal, and the scan electrode driving control signal for driving a normal mode in S330. The erase mode is a driving mode for erasing the wall charge formed on the address electrode A near the sustain electrode X, and the normal mode is a typical driving mode according to the general driving waveform shown in FIG. 1.

FIG. 4 illustrates an operation of the controller for driving the erase mode.

As shown in FIG. 4, when the temperature of the PDP 100 is less than or equal to room temperature, the controller 200 outputs the address electrode driving control signal, the sustain electrode driving control signal, and the scan electrode driving control signal for driving the erase mode. First, the controller 200 outputs control signals for the reset period to each of the address electrode driver 300, the sustain electrode driver 400, and the scan electrode driver 500 and enables these drivers 300, 400, 500 to provide reset period signals to the electrodes X, Y, A to perform a reset operation in S421. Next, the controller 200 outputs control signals for the address period to each of the address electrode driver 300, the sustain electrode driver 400, and the scan electrode driver 500 and enables the drivers 300, 400, 500 to provide address period signals to the electrodes X, Y, A to perform an address operation in S422. Next, the controller 200 outputs control signals for the sustain period to each driver 300, 400, 500, and enables the drivers 300, 400, 500 to provide sustain period signals to the electrodes X, Y, A to perform a sustain operation in S423. A sustain discharge pulse is applied to the scan electrode Y and the sustain electrode X in turn. When reaching a first period for applying the last sustain discharge pulse to the sustain electrode X during the sustain period while repeating application of the sustain discharge pulse in S424, the controller 200 outputs a control signal for applying a waveform for erasing the wall charge formed on the address electrode A near the sustain electrode X to each address and sustain electrode A, X in S425.

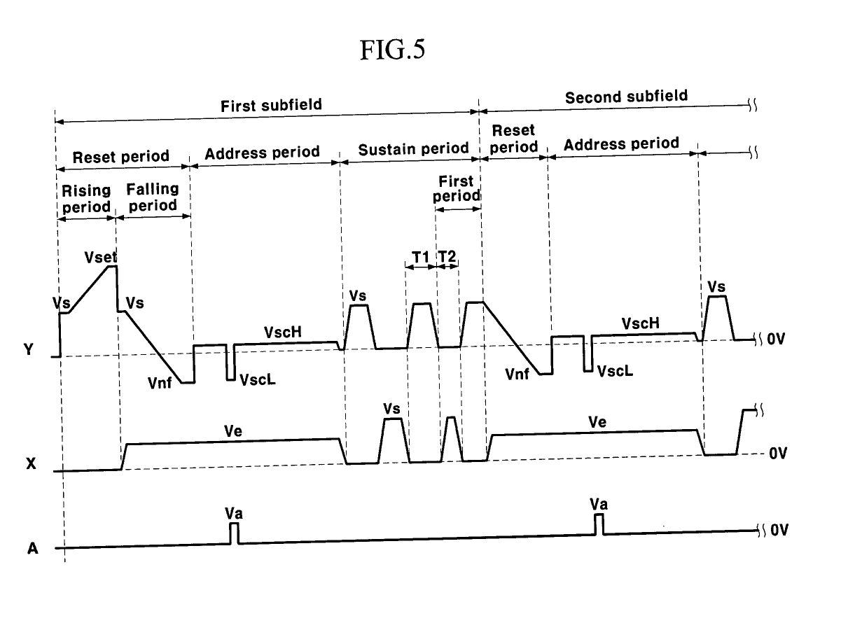

Hereinafter, referring to FIGS. 5, 6, 7, and 8, an erase waveform applied during the first period of the sustain period when the temperature of the PDP 100 is less than or equal to room temperature will be described in detail. As mentioned above, the first period of the sustain period generally means a period during which the last sustain discharge pulse for the sustain electrode X is applied to the sustain electrode X during the sustain period. For better understanding, among a plurality of subfields only two subfields are described, and the two subfields are respectively referred to as a first subfield and a second subfield. A reset period of the first subfield includes a rising period and a falling period, and a reset period of the second subfield includes a falling period only. During the reset period of the first subfield, all the discharge cells are initialized, whereas during the reset period of the second subfield only discharge cells in which the sustain discharge occurred during the first subfield are initialized. The reset period including the rising period and the falling period is defined to be a main reset period, and the reset period including only the falling period is defined to be an auxiliary reset period.

FIG. 5 illustrates the driving waveform of the PDP according to the first exemplary embodiment of the present invention.

As shown in FIG. 5, during the rising period of the reset period of the first subfield, a voltage of the scan electrode Y is increased from Vs to Vset while maintaining the sustain electrode X at 0V. Then, a weak reset discharge occurs between the scan electrode Y and the address electrode A, and between the scan electrode Y and the sustain electrode X. Accordingly, negative (−) wall charges are formed on the scan electrode Y, and positive (+) wall charges are formed on the sustain electrode X and the address electrode A.

During the falling period of the reset period of the first subfield, the voltage of the scan electrode Y is gradually decreased from the voltage Vs to a negative voltage Vnf while maintaining the voltage of the address electrode A at Ve. While the voltage of the scan electrode Y decreases, a weak discharge occurs between the scan electrode Y and the sustain electrode X, and between the scan electrode Y and the address electrode A. Accordingly, the negative (−) wall charges formed on the scan electrode Y and the positive (+) wall charges formed on the sustain electrode X and the address electrode A are eliminated, and the discharge cell is initialized.

Subsequently, during the address period for selection of turn-on discharge cells, a scan pulse of a negative voltage VscL is sequentially applied to the selected scan electrodes Y, and non-selected scan electrodes Y are biased at a voltage VscH. The voltage VscL is called a scan voltage, and VscH is called a non-scan voltage. An address pulse having voltage Va is applied to the address electrodes A of the discharge cells to be selected among the a plurality of discharge cells formed along the selected scan electrodes Y to which the voltage VscL is applied. The address electrodes A not to be selected are biased at a reference voltage (0V in FIG. 5). Then, in the selected discharge cells having the address electrodes A and the scan electrodes Y, to which the voltage Va and the voltage VscL are respectively applied, an address discharge occurs. Accordingly, a positive (+) wall charge is formed on the scan electrodes Y, and a negative (−) wall charge is formed on the sustain electrodes X. A negative (−) wall charge is also formed on the address electrodes A.

Subsequently, during the sustain period of the first subfield, sustain discharge pulses having a high level voltage (Vs in FIG. 5) and a low level voltage (0V in FIG. 5) of opposite phases are applied to the scan electrode Y and the sustain electrode X. When the voltage Vs is applied to the scan electrode Y, 0V is applied to the sustain electrode X, and when the voltage Vs is applied to the sustain electrode X, 0V is applied to the scan electrode Y. Because of the wall voltage formed between the scan electrode Y and the sustain electrode X by the address discharge during the address period, a discharge occurs between the scan electrode Y and the sustain electrode X due to the wall voltage and the voltage Vs.

Afterward, the sustain discharge pulse is applied to the scan electrode Y and the sustain electrode X as frequently as a number corresponding to a weight value of the subfield.

According to the first exemplary embodiment of the present invention, shown in FIG. 5, a width T2 of the sustain discharge pulse applied during the first period of the sustain period is set to be a narrow width. Here, a narrow width pulse is a pulse which has a substantially equivalent voltage to the voltage Vs of the sustain discharge pulse applied during the sustain period, but has a narrower pulse width T2 than the sustain discharge pulse of a width T1. For example, when the width T1 of the sustain discharge pulse applied to the scan electrode Y is 2 to 2.5 μps, the width T2 of the sustain discharge pulse applied to the sustain electrode X during the first period may be set to be 1 to 1.5 μps.

As described above, when the width T2 of the sustain discharge pulse applied to the sustain electrode X, during the first period of the sustain period, is set to be narrow, in addition to a general sustain discharge, a strong discharge of short duration occurs. Accordingly, it may be difficult to form a wall charge on the scan electrode Y, the sustain electrode X, and the address electrode A. Therefore, the quantity of the wall charge formed between the sustain electrode X and the address electrode A is reduced, so that the wall charge of the address electrode A formed near the sustain electrode X may be reduced. Accordingly, with an auxiliary reset afterward, the wall charge formed on the address electrode A can be sufficiently controlled, and misfiring during the address period may be prevented.

After the sustain period of the first subfield ends, the second subfield begins. During the reset period of the second subfield, the voltage of the scan electrode Y starts from the sustain discharge pulse of the voltage Vs and is gradually decreased to voltage Vnf. The starting voltage Vs was applied to the scan electrode Y during the sustain period of the first subfield.

When the sustain discharge occurs during the sustain period of the first subfield, a negative (−) wall charge is formed on the scan electrode Y, and a positive (+) wall charge is formed on the sustain electrode X and the address electrode A. Therefore, while gradually decreasing the voltage applied to the scan electrode Y, when the sum of the voltage applied to the scan electrode Y and the wall voltage formed on the discharge cell reaches a discharge firing voltage, a weak discharge occurs as in the falling period of the reset period of the first subfield. Since a final voltage Vnf of the scan electrode Y is substantially the same as the final voltage Vnf of the falling period of the first subfield, a wall charge after the falling period of the second subfield becomes substantially equivalent to the wall charge after the falling period of the first subfield.

The discharge cells in which the address discharge did not occur during the address period of the first subfield maintain the wall charge existing after the falling period of the first subfield. Because the sum of the voltage applied to the scan electrode Y and the wall voltage formed in the discharge cell after the falling period of the first subfield is set to be near the discharge firing voltage, a discharge will not occur when the voltage of the scan electrode Y is decreased until it reaches the voltage Vnf. In other words, in these discharge cells, a discharge will not occur during the reset period of the second subfield, and a wall charge state established during the reset period of the first subfield is maintained.

In short, when the reset period of a subfield includes only a falling period, the reset discharge occurs only in those discharge cells where the sustain discharge has occurred during the previous subfield. The reset discharge will not occur in the other discharge cells where the sustain discharge did not occur during the previous subfield.

The address period and the sustain period of the second subfield are substantially the same as those of the first subfield. However, the number of sustain discharge pulses during the sustain period of the second subfield is determined corresponding to a weight value of the second subfield.

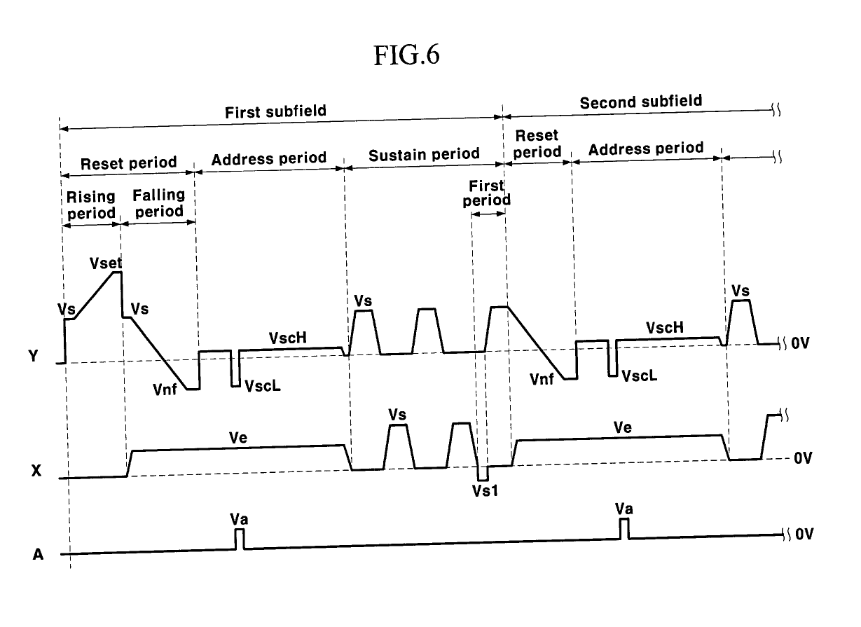

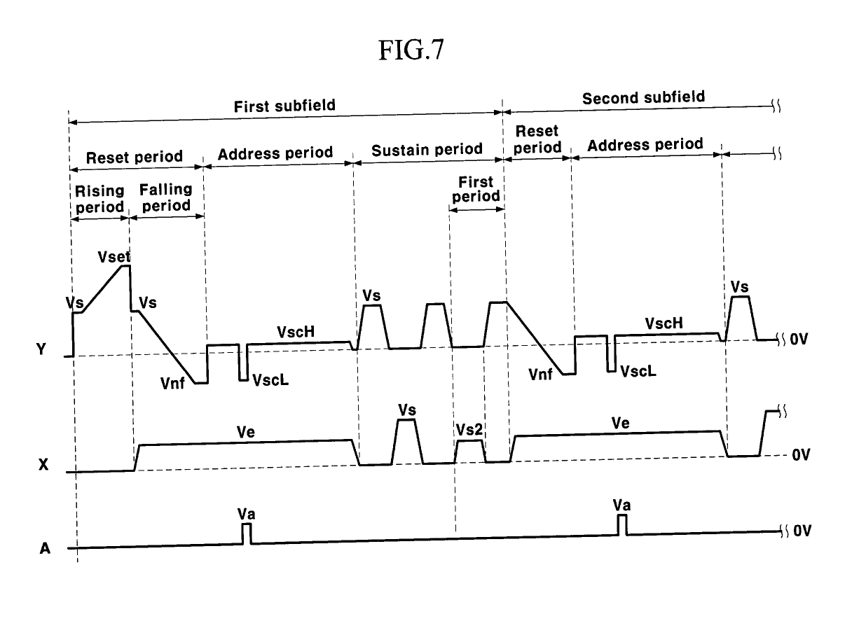

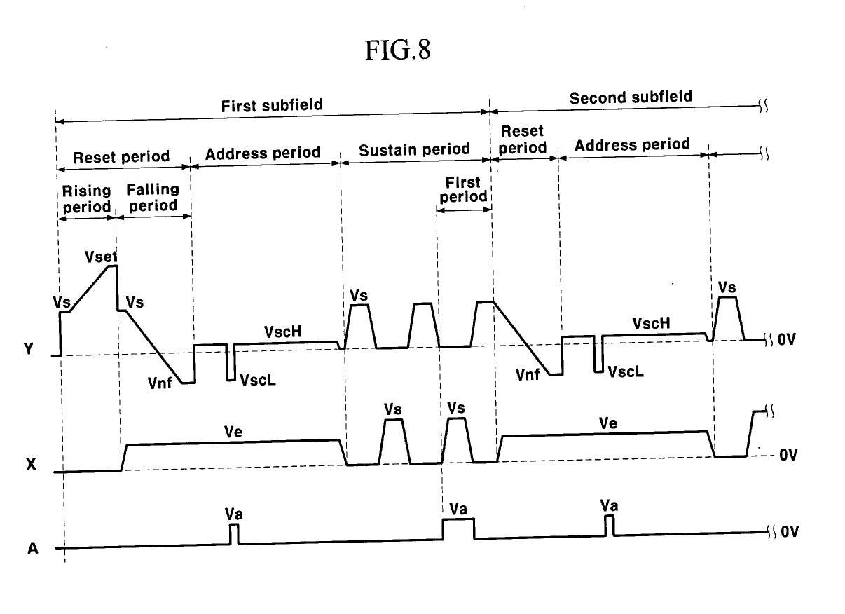

In the first exemplary embodiment of the present invention, the wall charges of the address electrode A formed near the sustain electrode X may be reduced by setting the width T2 of the sustain discharge pulse to be narrow during the first period of the sustain period. However, other schemes may also be applied as described in the following embodiments. Hereinafter, referring to FIG. 6, FIG. 7, and FIG. 8, other exemplary embodiments will be described.

FIGS. 6, 7, and 8 respectively illustrate driving waveforms of the PDP according to the second, third, and fourth exemplary embodiments of the present invention.

As shown in FIG. 6, during the first period of the sustain period, after applying the sustain discharge pulse to the sustain electrode X, a negative voltage Vs1 may be applied to the sustain electrode X. Then, the last sustain discharge pulse Vs is applied to the scan electrode Y.

When, during the sustain period of the first subfield, the sustain discharge pulse of the voltage Vs is applied to the sustain electrode X, by sustain discharge, a negative (−) wall charge is formed on the sustain electrode X, and a positive (+) wall charge is formed on the address electrode A and the scan electrode Y. In this wall charge state, when the negative voltage Vs1 is applied to the sustain electrode X, the wall charge of the address electrode A formed near the sustain electrode X is erased. Accordingly, with an auxiliary reset during the second subfield, the wall charge formed on the address electrode A can be sufficiently controlled, and misfiring during the subsequent address period of the second subfield may be prevented.

According to the third exemplary embodiment of the present invention shown in FIG. 7, during the first period of the sustain period, a sustain discharge pulse having voltage Vs2 lower than Vs may be applied to the sustain electrode X. When the voltage Vs2 lower than Vs is applied to the sustain electrode X, a discharge will not occur and a wall charge caused by the discharge will not be formed. Consequently, the wall charge not only on the address electrode A but also on the other electrodes may be reduced. Accordingly, with an auxiliary reset during the second subfield, the wall charge formed on the address electrode can be sufficiently controlled, and the misfiring during the address period may be prevented.

As shown in FIG. 8, in the fourth exemplary embodiment, when the last sustain discharge pulse having the voltage Vs is applied to the sustain electrode X during the first period of the sustain period, the address electrode A may be biased to have a positive voltage Va. When the address electrode A is biased to have a positive voltage Va while the voltage Vs is applied to the sustain electrode X, a voltage difference between the sustain electrode X and the address electrode A is reduced, and the wall charge formed between the sustain electrode X and the address electrode A may also be reduced. Similar to the first, second, and third exemplary embodiments of the present invention, with an auxiliary reset during a subsequent second subfield, the wall charge formed on the address electrode A can be sufficiently controlled, and misfiring during the address period may be prevented.

Other than the waveforms illustrated in the first, second, third, and fourth exemplary embodiments of the present invention, various waveforms that can reduce the wall charge formed on the address electrode A near the sustain electrode X may be applied in order to prevent misfiring during a subsequent address period.

In a typical plasma display device, discharge voltage, and discharge characteristics of a panel are varied according to temperature. In other words, at a high temperature, an opposed discharge between a scan electrode Y and an address electrode A occurs easily, and at a low temperature, the opposed discharge occurs with difficulty.

Because the opposed discharge between the scan electrode Y and the address electrode A occurs with difficulty at a low temperature, when initializing a discharge cell in which a sustain discharge has occurred during a previous subfield, a wall charge formed on an address electrode A near the scan electrode Y can be erased but a wall charge formed on an address electrode A near the sustain electrode X may not be erased, and charge may remain on the address electrode A.

In the case where a large amount of charge remains on the address electrode A, a misfire in an address discharge during a latter address period may occur. Therefore, according to an exemplary embodiment of the present invention, at a low temperature, by applying an erase waveform for erasing the wall voltage of the address electrode A formed near the sustain electrode X, a misfire during the address period may be prevented.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims and their equivalents.

What is claimed is:

1. A method for driving a plasma display panel during a frame, the frame divided into a plurality of subfields, each subfield having a reset period, an address period, and a sustain period, the plasma display panel comprising a first electrode extending along a first direction, a second electrode extending along the first direction, and a third electrode formed in a direction crossing the first electrode and the second electrode, the method comprising, during the sustain period:
applying a plurality of sustain discharge pulses having a first voltage alternately to the first electrode and the second electrode to cause a sustain discharge; and
applying an erase waveform to the second electrode for erasing a wall voltage of the third electrode formed near the second electrode during a first period of the sustain period.

2. The method of claim 1, wherein the first period comprises a period for substantially applying a last sustain discharge pulse to the second electrode.

3. The method of claim 2, wherein the erase waveform has a narrower pulse width than a sustain discharge pulse applied to the second electrode.

4. The method of claim 2, wherein the erase waveform has a lower voltage during the first period than the first voltage applied to the second electrode.

5. The method of claim 2, wherein the erase waveform biases the second electrode with a negative voltage after applying a sustain voltage to the second electrode.

6. The method of claim 2, wherein the erase waveform applies a sustain discharge pulse to the second electrode, while the third electrode is biased with a positive voltage.

7. The method of claim 2, wherein a last sustain discharge pulse among the plurality of sustain discharge pulses during the sustain period is applied to the first electrode.

8. The method of claim 7, wherein during a reset period following the sustain period, the voltage of the first electrode is gradually decreased after applying the last sustain discharge pulse to the first electrode.

9. A method for driving a plasma display panel, the plasma display panel having a first electrode and a second electrode formed along a first, direction, and a third electrode formed in a direction crossing the first electrode and the second electrode, a sustain discharge pulse being applied during a sustain period to the first electrode and the second electrode, the method comprising:
detecting a temperature of the plasma display panel; and
applying an erase waveform for erasing a wall voltage of the third electrode formed near the second electrode during a first period of the sustain period when the detected temperature is lower than room temperature.

10. The method of claim 9, wherein the first period comprises a period for substantially applying a last sustain discharge pulse to the second electrode.

11. The method of claim 10, wherein the erase waveform applied to the second electrode during the first period has a narrower pulse width than a sustain discharge pulse applied to the second electrode.

12. The method of claim 10, wherein the erase waveform applied to the second electrode during the first period has a lower voltage than a first voltage applied to the second electrode prior to the first period.

13. The method of claim 10, wherein the erase waveform biases the second electrode with a negative voltage after applying a sustain voltage to the second electrode.

14. The method of claim 10, wherein the erase waveform biases the third electrode with a positive voltage while applying a sustain discharge pulse to the second electrode.

15. The method of claim 10, wherein a last sustain discharge pulse among the plurality of the sustain discharge pulses during the sustain period is applied to the first electrode.

16. The method of claim 15, wherein, during a reset period following the sustain period, the voltage of the first electrode is gradually decreased after applying the last sustain discharge pulse to the first electrode.

17. A plasma display device, comprising:
a plasma display panel comprising a scan electrode, a sustain electrode, and an address electrode formed in a direction crossing the scan electrode and the sustain electrode;
a temperature detector for detecting a temperature of the plasma display panel;
a driver for performing a sustain discharge between the scan electrode and the sustain electrode by applying a sustain discharge pulse to the scan electrode and the sustain electrode during a sustain period; and
a controller for controlling the driver corresponding to the temperature of the plasma display panel during a first period of the sustain period so that a wall charge formed on the address electrode may be erased.

18. The plasma display device of claim 17, wherein during the first period, when the temperature of the plasma display panel is lower than a first temperature, the controller controls the driver so that the wall charge formed on address electrode may be erased.

19. The plasma display device of claim 18, wherein the first period comprises a period for applying a last sustain discharge pulse for the sustain electrode to the sustain electrode.

20. The plasma display device of claim 17, wherein during a reset period following the sustain period, the driver initializes a discharge cell in which a sustain discharge has occurred during the sustain period.
